(19) United States
(12) Patent Application Publication
(10) Pub. No.: US 2019/0096304 A1
(43) Pub. Date: Mar. 28, 2019

(54) DISPLAY PANEL AND DISPLAY APPARATUS USING THE SAME

(71) Applicants: HKC Corporation Limited, Shenzhen City, Guangdong (CN); Chongqing HKC Optoelectronics Technology Co., Ltd., Chongqing (CN)

(72) Inventor: Shuixiu HU, Chongqing (CN)

(21) Appl. No.: 15/745,528

(22) PCT Filed: Dec. 20, 2017
(86) PCT No.: PCT/CN2017/117340

§ 371 Date: Jan. 17, 2018

(30) Foreign Application Priority Data
Sep. 26, 2017 (CN) 201710882650.7

(51) Int. Cl. G09G 3/20

(52) U.S. Cl. CPC G09G 3/20; G09G 2310/08; G09G 2330/023; G09G 2300/0809; G09G 2300/0426

(57) ABSTRACT

This application relates to a display panel and a display apparatus thereof, includes: a substrate, a display area of the substrate includes a plurality of scan lines, data lines, active switches, and pixel units, the pixel units are separately coupled to the active switches, and the active switches is separately electrically coupled between the plurality of scan lines and the data lines; a source drive unit, electrically coupled to the data lines; a charge sharing switches, disposed among the data lines; and a control circuit, electrically coupled to control ends of the charge sharing switches, where the control circuit is configured to transmit a first signal to the control ends of the charge sharing switches to open the charge sharing switches, so that the data lines is electrically coupled to each other.

### BACKGROUND

### Technical Field

This application relates to the field of display technologies, and in particular, to a display panel and a display apparatus thereof.

### Related Art

During normal display of a TFT-LCD (active switch-liquid crystal display) panel, each pixel needs to be controlled by a gate drive circuit (gate driver) and a source drive circuit (source driver) in combination with scan lines (gate line) and data lines intertwining on a substrate, to display an image.

A method for driving a display includes: a system mainboard provides and transmits a color (for example, R/G/B) compression signal, a control signal, and a power supply to a control board; After being processed by a timing controller (TCON) on the control board, the signals are transmitted to a source circuit and a gate circuit on a printed circuit board; and necessary data and a necessary power supply are transmitted to a display area by using lines such as the scan lines, the data lines, and a power supply on the substrate, so that the display obtains the power supply and signals needed to present an image.

In normal cases, an output end of the source drive circuit is connected to a pixel unit in the display area, and data can be directly written into the panel. However, because parasitic capacitors and parasitic resistors exist in the panel, data signals output by the source drive circuit not only need to charge liquid crystal capacitors, but also need to charge parasitic resistors and parasitic capacitors. Consequently, not only a charging efficiency of the panel is reduced, but also a charging time is increased, reducing image quality. In the related art, every two data lines are considered as a group. Data lines in a same group are connected in a particular time period, so that charges on parasitic capacitors and parasitic resistors on the data lines perform neutralization. However, this is applicable only to a case where data voltage polarities of pixels on two columns and a same line are opposite. If data polarities on the two columns are the same, a voltage value of the parasitic capacitors and the parasitic resistors on the two data lines after charge sharing is an average value of two voltages, and the average value excessively deviates from a zero voltage, bringing a disadvantage to writing of data of a next line.

### SUMMARY

To resolve the foregoing technical problem, an objective of this application is to provide a display panel and a display apparatus thereof. By connecting all data lines, all the data lines simultaneously perform charge sharing, so as to effectively neutralize voltages of the data lines, thereby improving a charging efficiency.

The objective of this application is achieved and the technical problem of this application is resolved by using the following technical solutions. A display panel provided according to this application includes: a first substrate and a second substrate disposed opposite to each other, where the first substrate includes a display area and a wiring area on a periphery of the display area, the display area includes a plurality of scan lines, a plurality of data lines, a plurality of active switches, and a plurality of pixel units, the plurality of pixel units is separately coupled to the plurality of active switches, and the plurality of active switches is separately electrically coupled between the plurality of scan lines and the plurality of data lines; a source drive unit, electrically coupled to the plurality of data lines; a plurality of charge sharing switches, disposed among the plurality of data lines; and a control circuit, electrically coupled to control ends of the plurality of charge sharing switches, where the control circuit is configured to transmit a first signal to the control ends of the plurality of charge sharing switches to open the plurality of charge sharing switches, so that the plurality of data lines is electrically coupled to each other.

The technical problem of this application may be further resolved by using the following technical solutions.

In an embodiment of this application, a plurality of data line switches is further included, and is disposed between the source drive unit and the plurality of data lines, where the control circuit is electrically coupled to control ends of the plurality of data line switches, and provides a second signal to the control ends of the plurality of data line switches when providing the first signal; the first signal and the second signal have different potentials; when the plurality of charge sharing switches is opened, the plurality of data line switches is closed; and when the plurality of charge sharing switches are closed, the plurality of data line switches is opened.

In an embodiment of this application, a phase inversion unit is further included, where the phase inversion unit is disposed between the control circuit and the plurality of data line switches, the control circuit outputs the first signal, and the phase inversion unit converts the first signal into the second signal, and transmits the second signal to the plurality of data line switches.

In an embodiment of this application, an output end of the phase inversion unit is simultaneously connected to all of the plurality of data line switches.

In an embodiment of this application, each of the plurality of data line switches is connected to the phase inversion unit.

In an embodiment of this application, the control circuit is electrically coupled to the source drive unit and the source drive unit stops outputting data to the plurality of data lines when obtaining a second signal by using the control circuit.

In an embodiment of this application, the control circuit includes a selector, the plurality of charge sharing switches is divided into a plurality of switch groups, an input end of the selector is electrically coupled to the first signal, an output end of the selector is connected to a plurality of control lines, the plurality of control lines is separately electrically coupled to the plurality of switch groups, and the selector adjusts potentials of the plurality of control lines according to the first signal, to control opening and closing of the plurality of switch groups.

In an embodiment of this application, the plurality of control lines includes a first control line and a second control line, the plurality of switch groups includes a first switch group and a second switch group, the first switch group includes (odd-number)the charge sharing switches, the second switch group includes (even-number)th charge sharing switches, the first control line is electrically coupled to the first switch group, and the second control line is electrically coupled to the second switch group.

Another objective of this application is to provide a display panel, including: a first substrate and a second substrate disposed opposite to each other, where the first substrate includes a display area and a wiring area on a periphery of the display area, the display area includes a plurality of scan lines, a plurality of data lines, a plurality of active switches, and a plurality of pixel units, the plurality of pixel units are separately coupled to the plurality of active switches, and the plurality of active switches are separately electrically coupled between the plurality of scan lines and the plurality of data lines; a source drive unit, electrically coupled to the plurality of data lines; a plurality of charge sharing switches, disposed among the plurality of data lines; and a plurality of data line switches, disposed between the source drive unit and the plurality of data lines; a control circuit, electrically coupled to control ends of the plurality of charge sharing switches; and a phase inversion unit, where an output end of the phase inversion unit is electrically coupled to control ends of the plurality of data line switches, and an input end of the phase inversion unit is electrically coupled to the control circuit, where the control circuit transmits a first signal to the control ends of the plurality of charge sharing switches, to open the plurality of charge sharing switches, so that the plurality of data lines is electrically coupled to each other and voltages on the plurality of data lines are zero or approximately zero, and the phase inversion unit obtains the first signal to generate and transmit a second signal to the control ends of the plurality of data line switches, to close the plurality of data line switches.

Still another objective of this application is to provide a display apparatus, including: a control module; and a display panel, including: a first substrate and a second substrate disposed opposite to each other, where the first substrate includes a display area and a wiring area on a periphery of the display area, the display area includes a plurality of scan lines, a plurality of data lines, a plurality of active switches, and a plurality of pixel units, the plurality of pixel units is separately coupled to the plurality of active switches, and the plurality of active switches is separately electrically coupled between the plurality of scan lines and the plurality of data lines; a source drive unit, electrically coupled to the plurality of data lines; a plurality of charge sharing switches, disposed among the plurality of data lines; and a control circuit, electrically coupled to control ends of the plurality of charge sharing switches and the control module, where the control module provides a first signal to the control ends of the plurality of charge sharing switches to open the plurality of charge sharing switches, so that the plurality of data lines is electrically coupled to each other.

According to this application, by properly adjusting charge sharing lines without greatly changing an existing production flow, all data lines are connected before polarity conversion, so that all the data lines simultaneously perform charge sharing, effectively neutralize voltages of the data lines, accelerate charge neutralization on the data lines, and make the voltages on the data lines zero or approximate to zero, thereby improving a charging efficiency. In addition, processes not need to be greatly adjusted, and therefore original process requirements and product costs can be maintained.

### BRIEF DESCRIPTION OF THE DRAWINGS

FIG. 1a is a schematic architectural diagram of an exemplary display apparatus;

FIG. 1b is a schematic diagram of exemplary configuration of pixel units;

FIG. 1c is a schematic diagram of an equivalent circuit of an exemplary source drive circuit;

FIG. 1d is a waveform graph of a control signal of an exemplary source drive circuit;

FIG. 2a is a schematic diagram of an embodiment of an equivalent circuit of a source drive circuit of a display panel according to a method of this application;

FIG. 2b is a schematic diagram of an embodiment of an equivalent circuit of a source drive circuit of a display panel according to a method of this application;

FIG. 2c is a schematic diagram of an embodiment of an equivalent circuit of a source drive circuit of a display panel according to a method of this application;

FIG. 2d is a schematic diagram of an embodiment of an equivalent circuit of a source drive circuit of a display panel according to a method of this application; and

FIG. 3 is a waveform graph of an embodiment of a control signal of a source drive circuit of a display panel according to a method of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by a same reference number. In addition, for understanding and ease of description, the size and the thickness of each component shown in the accompanying drawings are randomly shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe technical means used in this application to achieve a preset inventive objective and technical effects of this application, specific implementations, structures, features, and effects of a drive apparatus provided according to this application are described in detail below with reference to the accompanying drawings and specific embodiments.

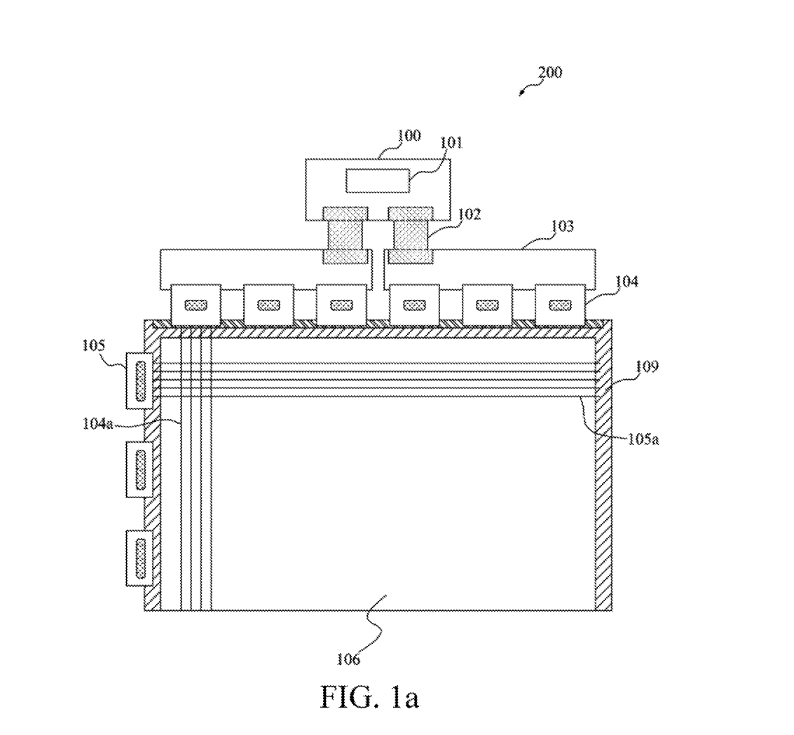

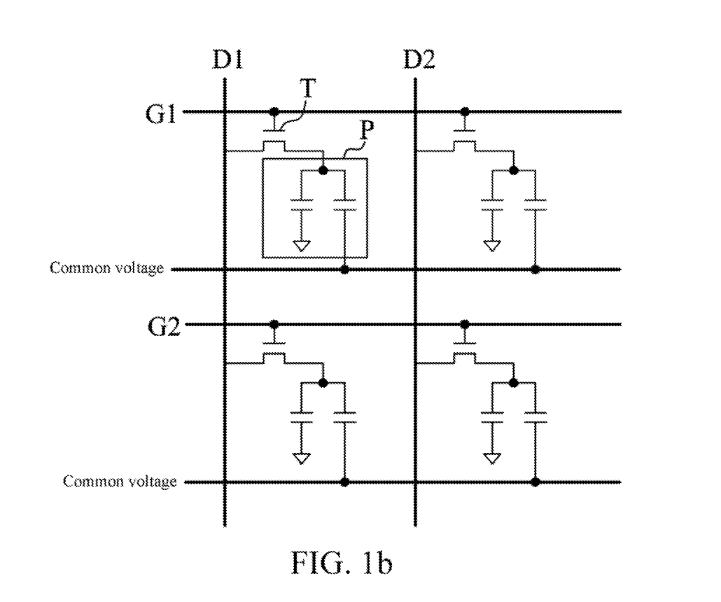

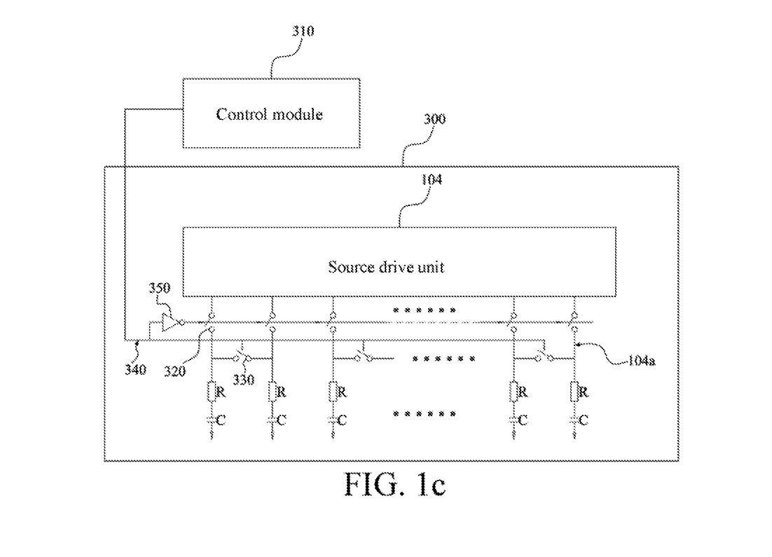

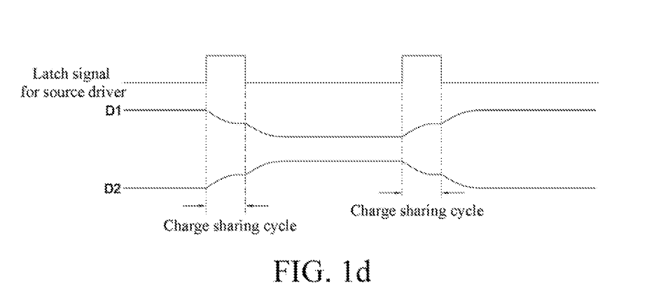

FIG. 1a is a schematic architectural diagram of an exemplary display apparatus. Referring to FIG. 1a, a display apparatus 200 includes a control board 100 including a timing controller (TCON) 101; and a printed circuit board 103, connected to the control board 100 by using a flexible flat cable (FFC) 102. A source drive unit 104 and a gate drive unit 105 are disposed in a wiring area 109, and are respectively connected to data lines 104a and scan lines 105a in a display area 106. In some embodiments, the gate drive unit 105 and the source drive unit 104 include but are not limited to chip-on-film forms.

A method for driving the display apparatus 200 includes: a system mainboard provides and transmits a color (for example, R/G/B) compression signal, a control signal, and a power supply to the control board 100; After being processed by the timing controller (TCON) 101 on the control board 100, the signals along with the power supply processed by a drive circuit are transmitted to the gate drive unit 105 and the source drive unit 104 of the printed circuit board 103 by using the flexible flat cable (FFC) 102. The gate drive unit 105 and the source drive unit 104 transmit necessary data and a necessary power supply to the display area 106, so that the display apparatus 200 obtains the power supply and signals needed to present an image.

FIG. 1b is a schematic diagram of exemplary configuration of pixel units. Refer to FIG. 1a to facilitate understanding of FIG. 1b. The gate drive unit 105 provides scan signals to the gate lines 105a line by line, and provides a scan signal to one of the scan lines 105a in each scan period. The data lines 104a of a display panel are opened line by line. The source drive unit 104 provides data to pixel units P by using the data lines 104a.

FIG. 1c is a schematic diagram of an equivalent circuit of an exemplary source drive circuit. Refer to FIG. 1a and FIG. 1b to facilitate understanding of FIG. 1c. The source drive unit 104 is connected to the data lines 104a. A data line switch 320 is disposed on a data output end of the source drive unit 104. Every two data lines 104a are considered a group. A charge sharing switch 330 is disposed between two data lines 104a in each group. A control module 310 is electrically coupled to a control end of the charge sharing switch 330 and a control end of the data line switch 320 by using a control circuit 340. A phase inversion unit 350 is disposed on the control circuit 340, and is disposed between the data line switch 320 and the control module 310. The control module 310 includes but is not limited to: the source drive unit 104, the timing controller 101, or another control component having a control signal. A parasitic capacitor C and a parasitic resistor R exist on a data line 104a.

FIG. 1d is a waveform graph of a control signal of an exemplary source drive circuit. Refer to FIG. 1a to FIG. 1c to facilitate understanding of FIG. 1d. The timing controller provides a latch signal for source driver (TP for short) to the source drive unit 104. When the latch signal for source driver has a high level, the source drive unit 104 does not output data. The control module 310 provides a charge sharing signal to the control circuit 340. At the moment, the charge sharing switch 330 is opened under control of the charge sharing signal, so that two adjacent data lines 104a are connected together. In a charge sharing cycle (CS cycle) (that is, a period when the latch signal for source driver has a high level), the adjacent two data lines 104a perform charge neutralization, and a signal waveform of the two data lines is shown in FIG. 1d. When the level of the latch signal for source driver is converted to a low level, the source drive unit 104 outputs a data signal, to charge pixel units P of a next line.

However, this method is applicable only to a case where data polarities of the two adjacent data lines 104a are opposite. If the data polarities of the two adjacent data lines 104a are opposite, a voltage polarity of a parasitic capacitor C and a parasitic resistor R on one data line is also opposite to a voltage polarity of a parasitic capacitor C and a parasitic resistor R on the other data line. During charge sharing, a voltage of parasitic capacitors C and parasitic resistors R on the two adjacent data lines 104a can be neutralized to a value approximate to zero, facilitating writing of data voltages of pixel units P of a next line. Otherwise, if the data polarities of the two adjacent data lines 104a are the same, after charge sharing, a voltage value of the parasitic capacitors C and the parasitic resistors R on the two adjacent data lines 104a is an average value of voltages in a group, and the average value excessively deviates from the zero voltage, bringing a disadvantage to writing of pixel units P of a next line.

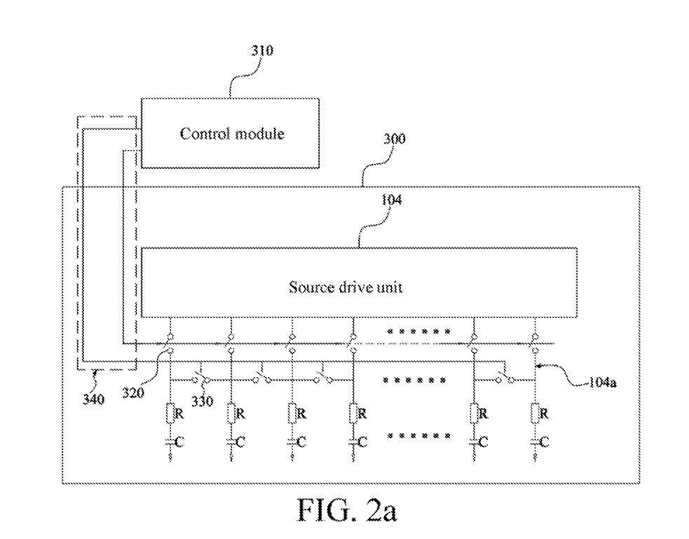

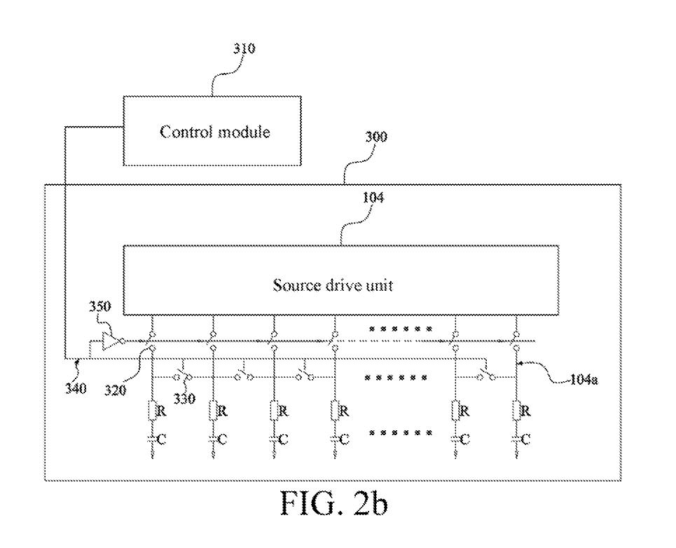

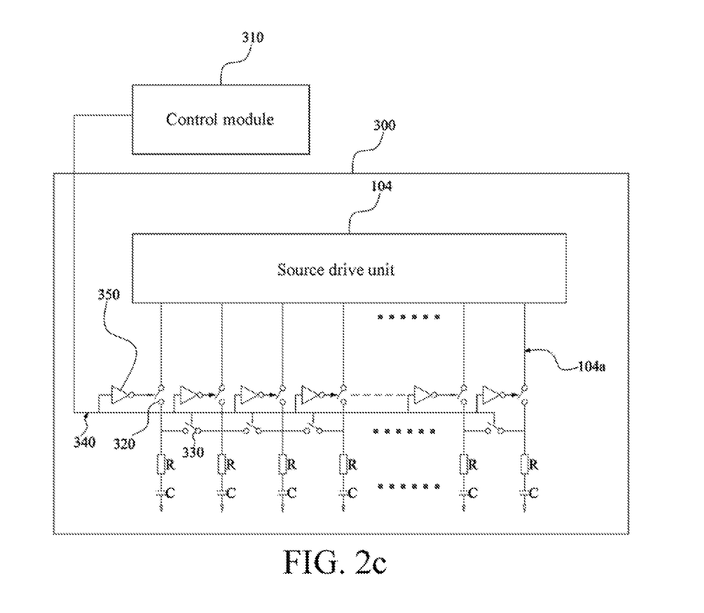

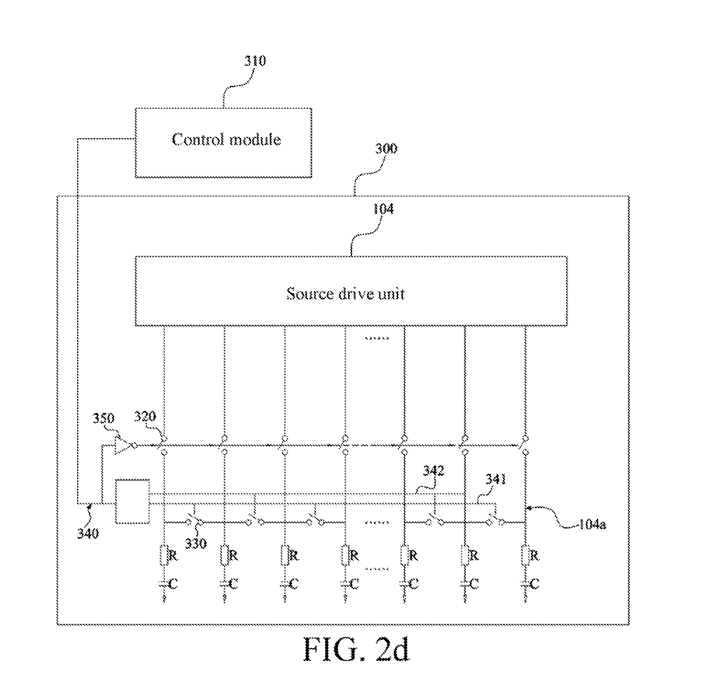

FIG. 2a is a schematic diagram of an embodiment of an equivalent circuit of a source drive circuit of a display panel according to a method of this application. Refer to FIG. 1a to FIG. 1d to facilitate understanding of related components of the display apparatus of the related art. Referring to FIG. 2a, in an embodiment of this application, a display panel 300 includes: a first substrate and a second substrate disposed opposite to each other, where the first substrate includes a display area 106 and a wiring area 109 on a periphery of the display area 106, the display area 106 includes a plurality of scan lines 105a, a plurality of data lines 104a, a plurality of active switches T, and a plurality of pixel units P, the plurality of pixel units P are separately coupled to the plurality of active switches T, and the plurality of active switches T are separately electrically coupled between the plurality of scan lines 105a and the plurality of data lines 104a; a source drive unit 104, electrically coupled to the plurality of data lines 104a; a plurality of charge sharing switches 330, disposed among the plurality of data lines 104a; and a control circuit 340, electrically coupled to control ends of the plurality of charge sharing switches 330. The control circuit 340 is configured to transmit a first signal to the control ends of the plurality of charge sharing switches 330 to open the plurality of charge sharing switches 330, so that the plurality of data lines 104a is electrically coupled to each other.

In some embodiments, the display panel 300 includes a plurality of data line switches 320. The plurality of data line switches 320 are disposed between the source drive unit 104 and the plurality of data lines 104a. The control circuit 340 is electrically coupled to control ends of the plurality of data line switches 320, and provides a second signal to the control ends of the plurality of data line switches 320 when providing the first signal. The first signal and the second signal have different potentials. When the plurality of charge sharing switches 330 are opened, the plurality of data line switches 320 is closed; and when the plurality of charge sharing switches 330 are closed, the plurality of data line switches 320 are opened.

In some embodiments, the control circuit 340 is electrically coupled to a control module 310. The first signal and the second signal are provided by the control module. The control module 310 includes but is not limited to: the source drive unit 104, a timing controller 101, or another control component having a control signal.

FIG. 2b is a schematic diagram of an embodiment of an equivalent circuit of a source drive circuit of a display panel according to a method of this application. In some embodiments, the display panel 300 includes a phase inversion unit 350. The phase inversion unit 350 is disposed between the control circuit 340 and the plurality of data line switches 320. The control circuit 340 outputs the first signal, and the phase inversion unit 350 converts the first signal into the second signal, and transmits the second signal to the plurality of data line switches 320.

In some embodiments, an output end of the phase inversion unit 350 is simultaneously connected to all of the plurality of data line switches 320.

FIG. 2c is a schematic diagram of an embodiment of an equivalent circuit of a source drive circuit of a display panel according to a method of this application. In some embodiments, each of the plurality of data line switches 320 is connected to the phase inversion unit 350.

In some embodiments, the control circuit 340 is electrically coupled to the source drive unit 104 and the source drive unit 104 stops outputting data to the plurality of data lines 104a when obtaining a second signal by using the control circuit 340.

FIG. 2d is a schematic diagram of an embodiment of an equivalent circuit of a source drive circuit of a display panel according to a method of this application. In some embodiments, the control circuit 340 includes a selector 360. The plurality of charge sharing switches 330 are divided into a plurality of switch groups. An input end of the selector 360 is electrically coupled to the first signal. An output end of the selector 360 is connected to a plurality of control lines. The plurality of control lines are separately electrically coupled to the plurality of switch groups. The selector 360 adjusts potentials of the plurality of control lines according to the first signal, to control opening and closing of the plurality of switch groups.

In some embodiments, the plurality of control lines includes a first control line 341 and a second control line 342. The plurality of switch groups includes a first switch group and a second switch group. The first switch group includes (odd-number)th charge sharing switches 330. The second switch group includes (even-number)th charge sharing switches 330. The first control line 341 is electrically coupled to the first switch group, and the second control line 342 is electrically coupled to the second switch group.

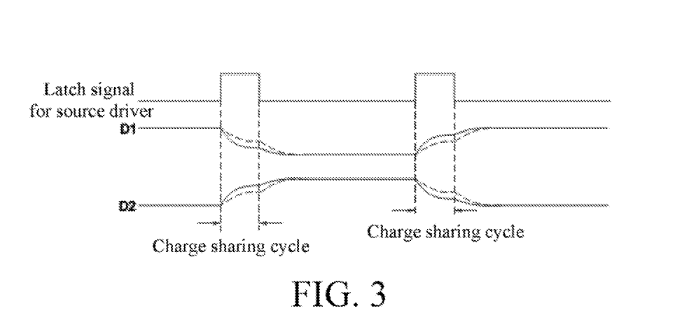

FIG. 3 is a waveform graph of an embodiment of a control signal of a source drive circuit of a display panel according to a method of this application. A timing controller 101 provides a latch signal for source driver (TP for short) to a source drive unit 104. When the latch signal for source driver has a high level, the source drive unit 104 does not output data. A control module 310 provides a charge sharing signal to a control circuit 340. At the moment, all charge sharing switches 330 are opened under control of the charge sharing signal, so that all data lines 104a are connected. That is, in a charge sharing cycle (CS cycle) (that is, a period when the latch signal for source driver has a high level), all the data lines 104a perform charge neutralization, and a signal waveform of the two adjacent data lines 104a is shown in FIG. 3. Compared with FIG. 1d (the dotted line part in FIG. 3 is the waveform shown in FIG. 1d), a speed for performing, by each line 104a, charge sharing, to form an effect of charge neutralization is higher, so that a voltage of each data line 104a is adjusted to a zero voltage or an approximately zero voltage within shorter time.

In an embodiment of this application, a display panel 300 includes: a first substrate and a second substrate disposed opposite to each other, where the first substrate includes a display area 106 and a wiring area 109 on a periphery of the display area 106, the display area 106 includes a plurality of scan lines 105a, a plurality of data lines 104a, a plurality of active switches T, and a plurality of pixel units P, the plurality of pixel units P is separately coupled to the plurality of active switches T, and the plurality of active switches T is separately electrically coupled between the plurality of scan lines 105a and the plurality of data lines 104a; a source drive unit 104, electrically coupled to the plurality of data lines 104a; a plurality of charge sharing switches 330, disposed among the plurality of data lines 104a; and a plurality of data line switches 320, disposed between the source drive unit 104 and the plurality of data lines 104a; a control circuit 340, electrically coupled to control ends of the plurality of charge sharing switches 330; and a phase inversion unit 350, where an output end of the phase inversion unit 350 is electrically coupled to control ends of the plurality of data line switches 320, and an input end of the phase inversion unit 350 is electrically coupled to the control circuit 340, where the control circuit 340 is configured to transmit a first signal to the control ends of the plurality of charge sharing switches 330, to open the plurality of charge sharing switches 330, so that the plurality of data lines 104a is electrically coupled to each other and voltages on the plurality of data lines 104a are zero or approximately zero, and the phase inversion unit 350 obtains the first signal to generate and transmit a second signal to the control ends of the plurality of data line switches 320, to close the plurality of data line switches 320.

In an embodiment of this application, a display apparatus includes a control module 310 and a display panel 300. The display panel 300 includes a first substrate and a second substrate disposed opposite to each other, where the first substrate includes a display area 106 and a wiring area 109 on a periphery of the display area 106, the display area 106 includes a plurality of scan lines 105a, a plurality of data lines 104a, a plurality of active switches T, and a plurality of pixel units P, the plurality of pixel units P are separately coupled to the plurality of active switches T, and the plurality of active switches T are separately electrically coupled between the plurality of scan lines 105a and the plurality of data lines 104a; a source drive unit 104, electrically coupled to the plurality of data lines 104a; a plurality of charge sharing switches 330, disposed among the plurality of data lines 104a; and a control circuit 340, electrically coupled to control ends of the plurality of charge sharing switches 330 and the control module 310. The control module 310 provides a first signal to the control ends of the plurality of charge sharing switches 330 to open the plurality of charge sharing switches 330, so that the plurality of data lines 104a is electrically coupled to each other.

According to this application, by properly adjusting charge sharing lines without greatly changing an existing production flow, all data lines are connected before polarity conversion, so that all the data lines simultaneously perform charge sharing, effectively neutralize voltages of the data lines, accelerate charge neutralization on the data lines, and make the voltages on the data lines zero or approximate to zero, thereby improving a charging efficiency. In addition, processes not need to be greatly adjusted, and therefore original process requirements and product costs can be maintained.

In some embodiments, the display panel of this application may be, for example, a liquid crystal display panel. However, this application is not limited thereto. The display panel may alternatively be an OLED display panel, a W-OLED display panel, a QLED display panel, a plasma display panel, a curved-surface display panel, or a display panel of another type.

Phrases such as “in some embodiments” and “in various embodiments” are repeatedly used. Usually, the phrases do not indicate same embodiments, but may also indicate same embodiments. Words, such as “comprise”, “have”, and “include” are synonyms, unless other meanings are indicated in the context.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A display panel, comprising:
a first substrate;
a second substrate disposed opposite to each other, wherein
the first substrate comprises a display area and a wiring area on a periphery of the display area, the display area comprises a plurality of scan lines, a plurality of data lines, a plurality of active switches, and a plurality of pixel units, the plurality of pixel units are separately coupled to the plurality of active switches, and the plurality of active switches are separately electrically coupled between the plurality of scan lines and the plurality of data lines;
a source drive unit, electrically coupled to the plurality of data lines;
a plurality of charge sharing switches, disposed among the plurality of data lines; and
a control circuit, electrically coupled to control ends of the plurality of charge sharing switches, wherein
the control circuit is configured to transmit a first signal to the control ends of the plurality of charge sharing switches to open the plurality of charge sharing switches, so that the plurality of data lines are electrically coupled to each other.

2. The display panel according to claim 1, further comprising:
a plurality of data line switches, disposed between the source drive unit and the plurality of data lines, wherein the control circuit is electrically coupled to control ends of the plurality of data line switches, and provides a second signal to the control ends of the plurality of data line switches when providing the first signal;
the first signal and the second signal have different potentials;
when the plurality of charge sharing switches are opened, the plurality of data line switches is closed; and
when the plurality of charge sharing switches are closed, the plurality of data line switches is opened.

3. The display panel according to claim 2, further comprising a phase inversion unit, wherein the phase inversion unit is disposed between the control circuit and the plurality of data line switches, the control circuit outputs the first signal, and the phase inversion unit converts the first signal into the second signal, and transmits the second signal to the plurality of data line switches.

4. The display panel according to claim 3, wherein an output end of the phase inversion unit is simultaneously connected to all of the plurality of data line switches.

5. The display panel according to claim 3, wherein each of the plurality of data line switches is connected to the phase inversion unit.

6. The display panel according to claim 1, wherein the control circuit is electrically coupled to the source drive unit.

7. The display panel according to claim 6, wherein the source drive unit stops outputting data to the plurality of data lines when obtaining a second signal by using the control circuit.

8. The display panel according to claim 1, wherein the control circuit comprises a selector.

9. The display panel according to claim 8, wherein the plurality of charge sharing switches is divided into a plurality of switch groups, an input end of the selector is electrically coupled to the first signal, an output end of the selector is connected to a plurality of control lines, the plurality of control lines are separately electrically coupled to the plurality of switch groups, and the selector adjusts potentials of the plurality of control lines according to the first signal, to control opening and closing of the plurality of switch groups.

10. The display panel according to claim 9, wherein the plurality of control lines comprises a first control line and a second control line, the plurality of switch groups comprises a first switch group and a second switch group, the first switch group comprises (odd-number)th charge sharing switches, the second switch group comprises (even-number)th charge sharing switches, the first control line is electrically coupled to the first switch group, and the second control line is electrically coupled to the second switch group.

11. A display panel, comprising:
a first substrate and a second substrate disposed opposite to each other, wherein
the first substrate comprises a display area and a wiring area on a periphery of the display area, the display area comprises a plurality of scan lines, a plurality of data lines, a plurality of active switches, and a plurality of pixel units, the plurality of pixel units are separately coupled to the plurality of active switches, and the plurality of active switches are separately electrically coupled between the plurality of scan lines and the plurality of data lines;
a source drive unit, electrically coupled to the plurality of data lines;
a plurality of charge sharing switches, disposed among the plurality of data lines; and
a plurality of data line switches, disposed between the source drive unit and the plurality of data lines;
a control circuit, electrically coupled to control ends of the plurality of charge sharing switches; and
a phase inversion unit, wherein an output end of the phase inversion unit is electrically coupled to control ends of the plurality of data line switches, and an input end of the phase inversion unit is electrically coupled to the control circuit, wherein
the control circuit is configured to transmit a first signal to the control ends of the plurality of charge sharing switches, to open the plurality of charge sharing switches, so that the plurality of data lines is electrically coupled to each other and voltages on the plurality of data lines are zero or approximately zero, and the phase inversion unit obtains the first signal to generate and transmit a second signal to the control ends of the plurality of data line switches, to close the plurality of data line switches.

12. A display apparatus, comprising:
a control module; and
a display panel, comprising:
a first substrate and a second substrate disposed opposite to each other, wherein
the first substrate comprises a display area and a wiring area on a periphery of the display area, the display area comprises a plurality of scan lines, a plurality of data lines, a plurality of active switches, and a plurality of pixel units, the plurality of pixel units are separately coupled to the plurality of active switches, and the plurality of active switches are separately electrically coupled between the plurality of scan lines and the plurality of data lines;
a source drive unit, electrically coupled to the plurality of data lines;
a plurality of charge sharing switches, disposed among the plurality of data lines; and
a control circuit, electrically coupled to control ends of the plurality of charge sharing switches and the control module, wherein
the control module provides a first signal to the control ends of the plurality of charge sharing switches to open the plurality of charge sharing switches, so that the plurality of data lines is electrically coupled to each other.

13. The display apparatus according to claim 12, further comprising:
a plurality of data line switches, disposed between the source drive unit and the plurality of data lines, wherein the control circuit is electrically coupled to control ends of the plurality of data line switches, and provides a second signal to the control ends of the plurality of data line switches when providing the first signal;
the first signal and the second signal have different potentials;
when the plurality of charge sharing switches is opened, the plurality of data line switches is closed; and
when the plurality of charge sharing switches is closed, the plurality of data line switches is opened.

14. The display apparatus according to claim 13, further comprising a phase inversion unit, wherein the phase inversion unit is disposed between the control circuit and the plurality of data line switches, the control circuit outputs the first signal, and the phase inversion unit converts the first signal into the second signal, and transmits the second signal to the plurality of data line switches.

15. The display apparatus according to claim 14, wherein an output end of the phase inversion unit is simultaneously connected to all of the plurality of data line switches.

16. The display apparatus according to claim 14, wherein each of the plurality of data line switches are connected to the phase inversion unit.

17. The display apparatus according to claim 12, wherein the control circuit is electrically coupled to the source drive unit.

18. The display apparatus according to claim 17, wherein the source drive unit stops outputting data to the plurality of data lines when obtaining a second signal by using the control circuit.

19. The display apparatus according to claim 12, wherein the control circuit comprises a selector.

20. The display apparatus according to claim 19, wherein the plurality of charge sharing switches is divided into a plurality of switch groups, an input end of the selector is electrically coupled to the first signal, an output end of the selector is connected to a plurality of control lines, the plurality of control lines are separately electrically coupled to the plurality of switch groups, and the selector adjusts potentials of the plurality of control lines according to the first signal, to control opening and closing of the plurality of switch groups.
